(19) United States
(12) Patent Application Publication
(10) Pub. No.: US 2025/0200848 A1
(43) Pub. Date: Jun. 19, 2025

(54) METHOD, APPARATUS, ELECTRONIC DEVICE, AND STORAGE MEDIUM FOR IMAGE LOADING

(71) Applicant: Beijing Zitiao Network Technology Co., Ltd., Beijing (CN)

(72) Inventor: Qingdong Cheng, Beijing (CN)

(21) Appl. No.: 18/851,652

(22) PCT Filed: Mar. 29, 2023
(86) PCT No.: PCT/CN2023/084884

§ 371 Date: Sep. 26, 2024

(30) Foreign Application Priority Data
Mar. 29, 2022 (CN) 202210323839.3

(51) Int. Cl. G06T 11/60; G06F 3/04845; G06F 3/0485; G06T 9/00

(52) U.S. Cl. CPC G06T 11/60; G06F 3/04845; G06F 3/0485; G06T 9/00

(57) ABSTRACT

Embodiments of the disclosure provide a method, apparatus, an electronic device, a storage medium, a computer program product and a computer program of image loading. A thumbnail of the target image is obtained in response to a selection operation for a target image, the thumbnail of the target image being preloaded in a memory; the thumbnail is rendered on a preloaded target display control, where the target display control is provided in an image editing interface, and the target display control is used for being called by the image editing interface so as to display an image loaded on the image editing interface; and an image to be edited is obtained by decoding the target image, and after an initialization of the image editing interface is completed, the image to be edited is re-rendered on the target display control through the image editing interface.

### CROSS REFERENCE TO RELATED APPLICATIONS

This application claims priority to Chinese Patent Application No. 202210323839.3, filed on Mar. 29, 2022 and entitled “METHOD, APPARATUS, ELECTRONIC DEVICE, AND STORAGE MEDIUM FOR IMAGE LOADING”, which is incorporated herein by reference in its entirety.

### FIELD

Embodiments of the present disclosure relate to the field of Internet technologies, and in particular, to a method, apparatus, an electronic device, a storage medium, a computer program product, and a computer program of image loading.

### BACKGROUND

Currently, photographing and photo editing have become one of the basic functions of a mobile terminal device typified by a smart phone. After taking a picture through a terminal device, a user further performs operations, such as cutting, toning, and adding a special effect, on the picture, so as to further edit the shot picture, thereby meeting a requirement for conveniently editing a picture on a mobile terminal device.

Currently, editing of an image by a mobile terminal device is generally implemented based on an image editor running in the mobile terminal device. The selected image to be edited is displayed on a display control in an image editing interface corresponding to the image editor, and in combination with an editing operation input by a user, the image to be edited is edited.

However, in an actual running process, after a user selects an image to be edited and before the image to be edited is displayed on an image editing interface, a screen is in a black screen state, which causes a problem of affecting the user's sense of view and use experience.

### SUMMARY

Embodiments of the present disclosure provide a method, apparatus, an electronic device, a storage medium, a computer program product, and a computer program of image loading, so as to overcome a black screen issue appears before an image to be edited is displayed on an image editing interface.

According to a first aspect, an embodiment of the present disclosure provides a method of image loading, including:
in response to a selection operation for a target image, obtaining a thumbnail of the target image, the thumbnail of the target image being preloaded in a memory; rendering the thumbnail on a preloaded target display control, wherein the target display control is provided in an image editing interface, and the target display control is used for being called by the image editing interface so as to display an image loaded on the image editing interface; and obtaining an image to be edited by decoding the target image, and re-rendering, after an initialization of the image editing interface is completed, the image to be edited on the target display control through the image editing interface.

According to a second aspect, an embodiment of the present disclosure provides an apparatus of image loading, including:
an obtaining module configured for obtaining a thumbnail of a target image in response to a selection operation for the target image, the thumbnail of the target image being preloaded in a memory;
a processing module configured for creating a first renderer, and rendering the thumbnail on a preloaded target display control, wherein the target display control is provided in an image editing interface, and the target display control is used for being called by the image editing interface so as to display an image loaded on the image editing interface; and
an editing module configured for obtaining an image to be edited by decoding the target image, and re-rendering, after an initialization of the image editing interface is completed, the image to be edited on the target display control through the image editing interface.

According to a third aspect, an embodiment of the present disclosure provides an electronic device, including:
a processor, and a memory communicatively connected to the processor;
the memory storing computer executable instructions; and
the processor executing the computer executable instructions stored in the memory to implement the method of image loading according to the foregoing first aspect and various possible variations of the first aspect.

According to a fourth aspect, an embodiment of the present disclosure provides a computer readable storage medium. The computer readable storage medium stores computer executable instructions. When a processor executes the computer executable instructions, the method of image loading according to the first aspect and various possible variations of the first aspect is implemented.

According to a fifth aspect, an embodiment of the present disclosure provides a computer program product, including a computer program. When being executed by a processor, the computer program implements the method of image loading according to the foregoing first aspect and various possible variations of the first aspect.

According to a sixth aspect, an embodiment of the present disclosure provides a computer program. When being executed by a processor, the computer program implements the method of image loading according to the foregoing first aspect and various possible variations of the first aspect.

### BRIEF DESCRIPTION OF THE DRAWINGS

To describe the technical solutions in the embodiments of the present disclosure or the related technologies more clearly, the following briefly introduces the accompanying drawings required for describing the embodiments or the related technologies, Apparently, the accompanying drawings in the following description show some embodiments of the present disclosure. Other drawings may also be obtained according to these drawings without creative efforts.

FIG. 1 is an application scenario diagram of an method of image loading according to an embodiment of the present disclosure.

FIG. 2 is a schematic diagram of a process of loading and displaying an image to be edited in a related solution.

FIG. 3 is a first schematic flowchart of a method of image loading according to an embodiment of the present disclosure.

FIG. 4 is a schematic diagram of rendering a thumbnail on a target display control according to an embodiment of the present disclosure.

FIG. 5 is a schematic diagram of an initiation process of an image editing interface according to an embodiment of the present disclosure.

FIG. 6 is a second schematic flowchart of a method of image loading according to an embodiment of the present disclosure.

FIG. 7 is a flowchart of a specific implementation of step S201 in the embodiment shown in FIG. 6.

FIG. 8 is a schematic diagram of determining an image to be selected based on sliding speed information and sliding distance information according to an embodiment of the present disclosure.

FIG. 9 is a flowchart of a specific implementation of step S205 in the embodiment shown in FIG. 6.

FIG. 10 is a structural block diagram of an apparatus of image loading according to an embodiment of the present disclosure.

FIG. 11 is a schematic structural diagram of an electronic device according to an embodiment of the present disclosure.

FIG. 12 is a schematic diagram of a hardware structure of an electronic device according to an embodiment of the present disclosure.

### DETAILED DESCRIPTION

In order to make objects, technical solutions and advantages of the embodiments of the present disclosure more apparent, the technical solutions in the embodiments of the present disclosure will be described below in a clearly and fully understandable way in connection with the drawings related to the embodiments of the present disclosure. Obviously, the described embodiments are only a part but not all of the embodiments of the present disclosure. All other embodiments obtained by persons of ordinary skill in the art based on the embodiments of the present disclosure without creative efforts shall belong to the scope of protection of the present disclosure.

Application scenarios of the embodiments of the present disclosure will be explained below:

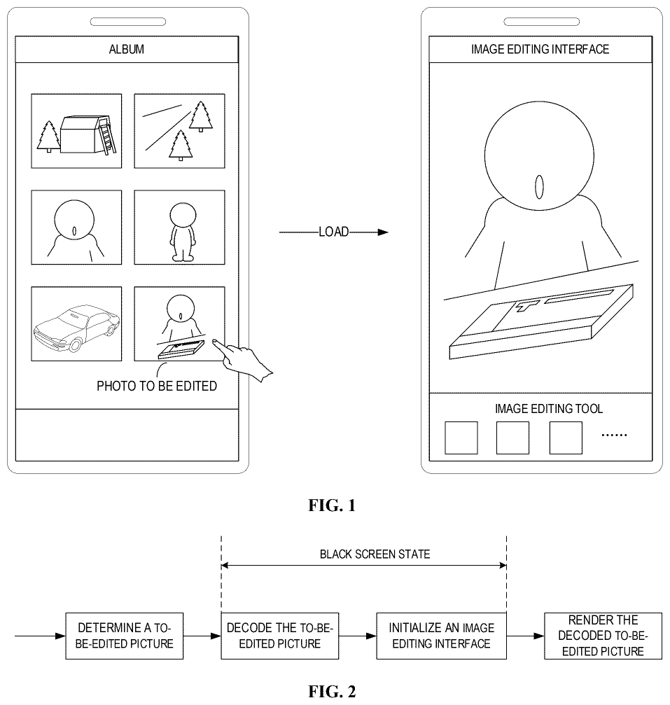

FIG. 1 is an application scenario diagram of an method of image loading provided by an embodiment of the present disclosure. The method of image loading provided by the embodiment of the present disclosure may be applied to an application scenario of editing an image through a mobile terminal device. Specifically, as shown in FIG. 1, an executing entity of the method according to the embodiment of the present disclosure may be a terminal device, for example, a smart phone shown in FIG. 1. For example, a plurality of photos are displayed in the form of thumbnails in an interface of a “album” in the smart phone. A user selects a to-be-edited photo from the “album” by means of clicking a thumbnail, and then the smart phone loads the selected to-be-edited photo, starts an image editing interface, and displays the to-be-edited photo in a display control (View) of the image editing interface. Then, the user may edit the image by using an image editing tool (a function control) provided in the image editing interface.

Further, in the foregoing application scenario, that is, an application scenario in which image editing is performed on the mobile terminal device, the process in which a smart phone loads and displays a to-be-edited photo is applied is special compared with an application scenario in which a non-mobile terminal device performs image editing. FIG. 2 is a schematic diagram of a process of loading and displaying an image to be edited in conventional solutions. As shown in FIG. 2, after obtaining a user instruction and determining a to-be-edited photo, a smart phone first decodes the to-be-edited photo, and then the image editing interface is initialized. Afterwards, the decoded to-be-edited photo is rendered in the display control of the image editing interface.

As shown in FIG. 2, before a decoded to-be-edited picture is rendered, a terminal device may have a blank screen state for a period of time. This is because, in the process of loading and displaying an image to be edited as shown in the figure, the image to be edited is limited by an operation manner of the mobile terminal device, a size of the screen, and device operation capability, different from a terminal device (for example, a PC) which is a non-mobile terminal, only one photo is usually edited at a time. Therefore, for an application scenario of a mobile terminal, in the conventional solutions, once one to-be-edited photo is selected each time, an image editing interface is started and initialized once. After the editing of the image to be edited is completed, the image editing interface is exited. Afterwards, if the image editing needs to be performed again, the foregoing procedure of initializing the image editing interface needs to be repeated. Therefore, the image editing interface needs to be initialized each time when an image is edited, so as to display the decoded image, which leads to time consumption caused by the initialization of the image editing interface, and further lead to a black screen issue to the screen.

Embodiments of the present disclosure provide an method of image loading to solve the above problem.

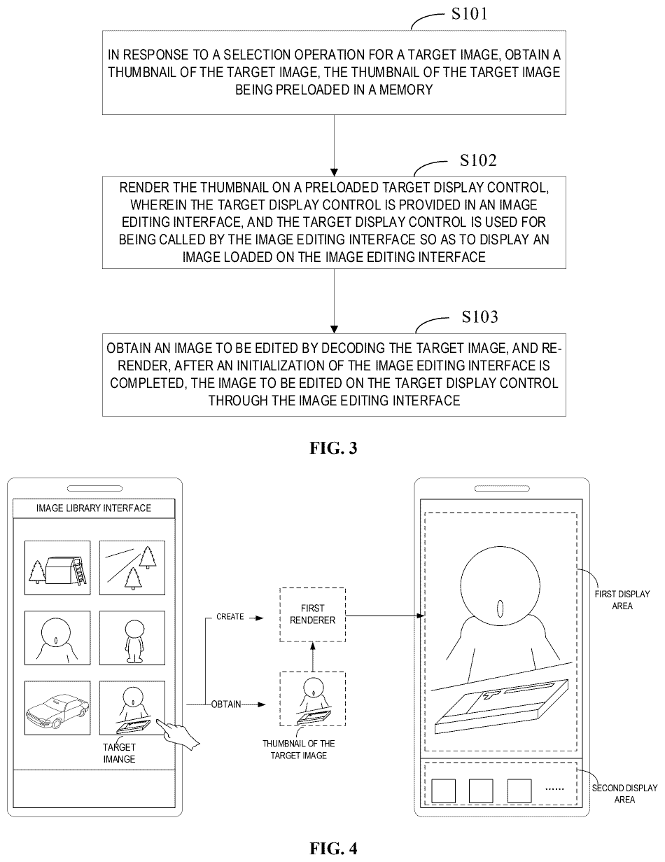

FIG. 3 is a first schematic flowchart of an method of image loading according to an embodiment of the present disclosure. The method according to the embodiment of the present disclosure may be applied to a terminal device. The method of image loading includes:
Step S101: in response to a selection operation for a target image, obtain a thumbnail of the target image, whereby the thumbnail of the target image is preloaded in a memory.

For example, referring to a schematic diagram of an application scenario in which image editing is performed on a mobile terminal device as shown in FIG. 1, an executing entity of the method of image loading provided in the embodiment of the present disclosure may be a terminal device, for example, a smartphone. Specifically, the terminal device has an interaction interface, and displays a plurality of images via the interaction interface. For example, an image library application (Application, APP) such as an “album” or a “photo” is running in the terminal device, and images stored in the terminal device are displayed by running the image library application, so that a user can edit the displayed images.

Specifically, after a user performs a selection operation (for example, clicking and selecting) on a displayed image through an operation interface, a terminal device responds to the selection operation, determines a target image corresponding to the selection operation, and then acquires a thumbnail corresponding to the target image. The thumbnail is a low-resolution image used for previewing a target image. With reference to the schematic diagram shown in FIG. 1, in an interface of an “album”, each target image is displayed as a thumbnail, i.e. the thumbnail has been preloaded in a memory and rendered in a corresponding region in the interface of the “album”. Since the resolution of a thumbnail is lower than that of a corresponding original image, the volume thereof is also updated, the corresponding loading speed is faster, and fewer resources are occupied.
Step S102: render a thumbnail on a target display control, where the target display control is provided in an image editing interface, and the target display control is invoked by the image editing interface to display an image loaded on the image editing interface.

For example, after a target image is determined based on a selection operation, a step of image decoding and initializing an image editing interface is performed in the conventional solutions. In an embodiment of the present disclosure, for example, after a thumbnail corresponding to a target image is acquired, a lightweight renderer for rendering an image, that is, a first renderer, is created; and a control for bearing an image, i.e. a target display control, so that a thumbnail is rendered onto the target display control using the first renderer and the target display control. On the one hand, since the first renderer is only used for rendering a thumbnail with a low resolution, the structure and function of the first renderer are very simple, and accordingly, the process of creating the first renderer and the process of rendering a thumbnail based on the first renderer may be completed within a short time duration. On the other hand, the target display control is for displaying an image to be edited within the image editing interface. Specifically, after the user performs a selection operation on the target image, the terminal device jumps from a currently displayed image library interface (for example, an ‘album’) to an image editing interface used for editing a target image. Taking an Android system as an example, jumping between interfaces may be implemented by means of a corresponding activity, while the target display control may be a view component in an Android system. The view may be carried and displayed through the activity. After the user performs a selection operation on the target image, the target display control is first displayed in the interaction interface of the terminal device through the corresponding activity (for example, activity corresponding to the image editing interface), and the target display control is invoked through the (setContentView ( ) method), so as to render the thumbnail on the target display control, thereby enabling the user to observe the thumbnail immediately through the interaction interface. Since this process consumes very little time, the image editing interface for editing the target image is instantly opened visually.

FIG. 4 is a schematic diagram of rendering a thumbnail on a target display control according to an embodiment of the present disclosure. As shown in FIG. 4, after a user determines a target image by means of a selection operation, a terminal device preloads a thumbnail of the target image in a memory by reading the thumbnail, creates a first renderer, and renders the thumbnail on the target display control of an image editing interface by using the first renderer. For example, on an interaction interface of a terminal device, an image editing interface comprises a first display area and a second display area, wherein a target display control is provided in the first display area. After the first renderer is created and the thumbnail is rendered on the target display control in the image editing interface, a map corresponding to the function control in the image editing interface is rendered in the second display area through the first renderer or a further created second renderer. The function control of the image editing interface is a control for editing the image to be edited in the image editing interface, for example, zooming, cutting, setting a hue, etc. The map corresponding to the function control cannot trigger the action of the control, and therefore may be quickly rendered in the second display area without initializing. After a thumbnail is rendered in a first display region of an image editing interface, a map corresponding to a function control of the image editing interface is rendered in a second display region in the image editing interface, so that the image editing interface is consistent with a real and initialized image editing interface visually, thereby improving smoothness of the starting process of the image editing interface.

Further, in a possible implementation, after the thumbnails corresponding to the target images are obtained, a first renderer is created by using an independent process (for example, a second process), and the thumbnails are rendered based on the first renderer. The separate second process is different from the main process (namely, step S103) used for executing the image editing interface starting task. That is, the action of rendering a thumbnail on the target display control and the initialization step (namely, step S102 and step S103) of the image editing interface in the steps of the embodiments of the present disclosure may be performed synchronously, thereby further improving the initialization speed of the image editing interface.
Step S103: obtain an image to be edited by decoding the target image, and after the initialization of the image editing interface is completed, the image to be edited is rendered on the target display control through the image editing interface.

For example, after the thumbnails are rendered on the target display control through the above steps, the image editing interface has been started visually, then the target image is decoded to obtain an image to be edited, and the image editing interface is initialized based on the image to be edited, until the image editing interface is initialized completely. After the image editing interface is initialized, various components set in the image editing interface have all been loaded, for example, including a second renderer for rendering a high-quality image. Then, the image editing interface clears the thumbnail with a low resolution in the target display control, and by invoking the target display control and using the second renderer to draw the to-be-edited image with a high resolution to the target display control, re-rendering of the target display interface is completed. Meanwhile, various controls in the image editing interface may be normally triggered, and subsequently, the image to be edited of high resolution may be further edited in the image editing interface based on an editing instruction input by the user.

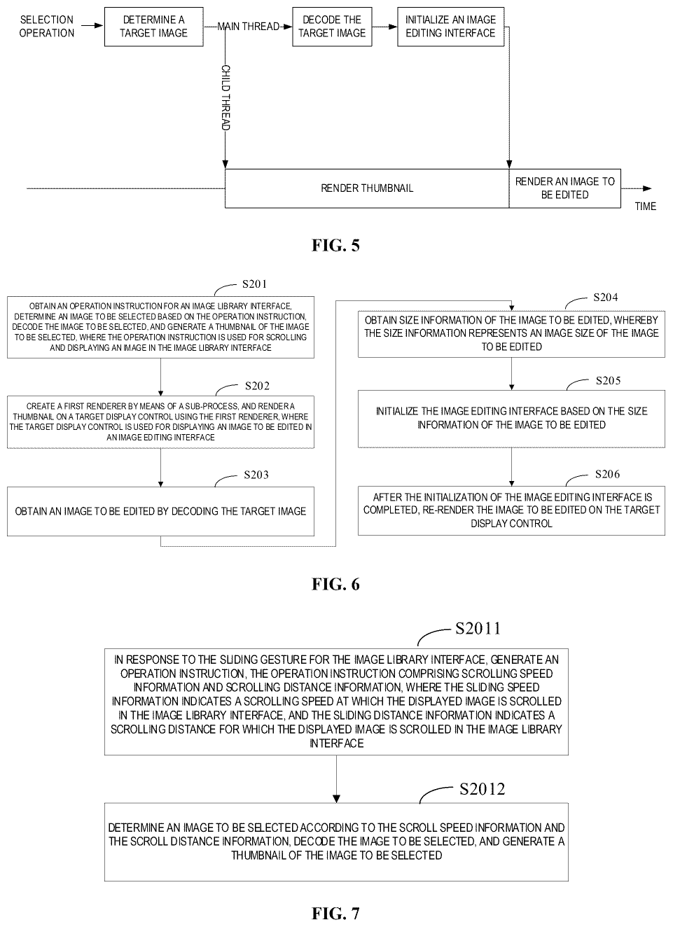

FIG. 5 is a schematic diagram of a start process of an image editing interface according to an embodiment of the present disclosure. As shown in FIG. 5, after receiving a selection operation for a target image, on the one hand, a sub-process acquires a thumbnail corresponding to the selected target image, creates a first renderer (not shown in the figure) for rendering the thumbnail, and then draws the thumbnail on a target display control using the first renderer; on the other hand, the main process decodes the selected target image to obtain an image to be edited, and initializes an image editing interface based on the image to be edited. After the initialization is completed, the image to be edited is displayed on the target display control, and the thumbnail is replaced (re-rendered). Since the thumbnail is preloaded in the memory, no additional decoding process is required, and the lightweight first renderer creation consumes less time. Therefore, the thumbnail of the target image may be displayed on the target display control quickly through the sub-process, and after the initialization of the image editing interface is completed, replacing an image to be edited with a high resolution, so that an image editing interface is virtually instantly started, improving the starting fluency of an image editing interface.

Optionally, after step S103, the method further includes:
in response to an editing instruction for an image to be edited, editing the image to be edited to obtain an edited image; compressing the edited image to obtain a thumbnail corresponding to the edited image; and loading the thumbnail corresponding to the edited image to a memory.

For example, after steps S101-S103 are performed, the image editing interface is initialized, and an image to be edited is displayed in the image editing interface; and a user may perform a corresponding editing operation by observing the image to be edited in the image editing interface, that is, inputting an editing instruction, for example, cutting, rotating, adjusting a hue, and the like, to the terminal device. After receiving an editing instruction for the image to be edited, the terminal device responds to the editing instruction to realize corresponding image processing steps, complete an image editing effect indicated by the editing instruction, and synchronously display the same. This process belongs to conventional solutions executed by a person skilled in the art, and is not repeated herein. After the editing process for the image to be edited is completed, the image to be edited is saved and an edited image is generated. After the terminal device generates the edited image, image compression, such as down-sampling, is performed on the edited image to generate a lower-resolution image, namely, a thumbnail corresponding to the edited image, loading the same into a memory, and subsequently exiting an image editing interface. When returning to the previous image library interface, the edited image may be previewed in the image library interface. If the edited image needs to be further edited for a second time, the thumbnail loaded in the memory may be directly used. By means of the method of steps S101-S103, fast display is performed on an image editing interface, thereby improving the visual starting speed of the image editing interface, improving the smoothness of operations in an image editing process.

In embodiments of the present disclosure, in response to a selection operation for the target image, a thumbnail of a target image is obtained; a first renderer is created, and a thumbnail is rendered on a target display control using the first renderer, whereby the target display control is provided in an image editing interface, and the target display control is used for being called by the image editing interface so as to display an image loaded to the image editing interface. A target image is decoded to obtain an image to be edited, and after the initialization of an image editing interface is completed, the image to be edited is re-rendered on a target display control via the image editing interface. Since a thumbnail corresponding to a preloaded target image is rendered on a target display control by configuring an additional lightweight first renderer, the blank screen issue caused before an initialization completion of an image editing interface can be avoided, so that the image editing interface is instantly started based on a user operation visually, thereby improving the smoothness of starting of the image editing interface and improving the use experience.

FIG. 6 is a second schematic flowchart of an method of image loading according to an embodiment of the present disclosure, the processes of step S101 and step S103 are described in detail in the embodiment of the present disclosure. The method of image loading includes:
Step S201: obtain an operation instruction for an image library interface, determine an image to be selected based on the operation instruction, decode the image to be selected, and generate a thumbnail of the image to be selected, where the operation instruction is used for scrolling and displaying an image in the image library interface.

For example, with reference to a schematic diagram of an application scenario shown in FIG. 1, a plurality of images are displayed in an image library interface, and a target image is determined based on a selection operation on the images in the image library interface. After the user performs a selection operation on the target image, the terminal device jumps from a currently displayed image library interface (for example, a ‘album’) to an image editing interface used for editing the target image. In this process, for example, if the image currently displayed on the image library interface does not include the target image, the user may perform a response operation on the image library interface, so as to scroll and display the image in the image library interface, thereby enabling the user to locate the target image to be selected.

In a possible implementation, thumbnails of all images in an image library interface are generated in sequence and loaded to a memory after the image library interface is started; therefore, thumbnails of target images may be directly obtained from the memory. However, although the loading speed of a thumbnail generated in this manner is fast, the resolution is generally low, and when the thumbnail is rendered on the target display control, the display effect is poor. In another possible implementation, in order to improve the resolution of a thumbnail, an image which may be edited by a user is predicted according to an operation instruction for an image library interface, so as to obtain an image to be selected, and decode the image to generate a thumbnail of the image to be selected with a specific higher resolution, thereby improving the display effect when rendering on the target display control.

For example, as shown in FIG. 7, specific implementation steps of step S201 include:
Step S2011: in response to the sliding gesture for the image library interface, generate an operation instruction, the operation instruction comprising scrolling speed information and scrolling distance information, where the sliding speed information indicates a scrolling speed at which the displayed image is scrolled in the image library interface, and the sliding distance information indicates a scrolling distance for which the displayed image is scrolled in the image library interface.

For example, in the embodiment of the present disclosure, the operation instruction for the image library interface is generated based on a sliding operation performed by a user on the image library interface. That is, the operation instruction is generated in response to the sliding gesture for the image library interface, wherein the operation instruction includes rolling speed information and rolling distance information. The operation instruction is obtained by collecting a slide gesture of a user through an interactive interface of the terminal device. More specifically, the scroll speed information may also indicate how fast the user's swiping gesture slides on the screen of the terminal device; the scroll distance information may also indicate a distance by which the user's swipe gesture slides on the screen of the terminal device. The user may perform several sliding operations on the image library interface by using several sliding gestures, and in such cases, the rolling speed information and the rolling distance information are information corresponding to one sliding gesture.
Step S2012: determine an image to be selected according to the scroll speed information and the scroll distance information, decode the image to be selected, and generate a thumbnail of the image to be selected.

Specifically, when a user selects a target image through an image library interface, the user roughly goes through two stages, one is a coarse positioning stage, the other one is a precise positioning stage. In the coarse positioning stage, a user makes a fast and long-distance slide gesture, to quickly scroll the image within the image library interface to roughly determine the image position within the image library interface. For example, if the user wants to select a picture taken on September 2020, he/she needs to implement a quick slide gesture on the image library interface, to locate the position of September 2020 within the image library interface (in this case, images within the image library interface are sorted by time). In the precise positioning stage, the user slowly scrolls and displays the image in the image library interface by means of a slide gesture with a slow speed and a short distance, so as to precisely locate the position of the image in the image library interface. For example, a target image is selected from a picture taken on September 2020 in the image library interface.

Whether a sliding gesture input by a user is at a coarse positioning stage or a precise positioning stage may be determined by means of rolling speed information and rolling distance information. If the sliding gesture is at the coarse positioning image stage, the image currently displayed in an image library interface is not determined as an image to be selected; otherwise, if the sliding gesture is at the precise positioning image stage, the image currently displayed in the image library interface is determined as the image to be selected. Then, the image to be selected is decoded to obtain a thumbnail with a higher resolution (namely, the thumbnail of the image to be selected), and is rendered to the target display control in subsequent steps, so that the display effect of the image displayed in the target display control is improved.

In a possible implementation, determining the image to be selected based on the sliding speed information and the sliding distance information comprises: in response to that the scrolling speed indicated by the scrolling speed information is less than a speed threshold and the scrolling distance indicated by the scrolling distance information is less than a distance threshold, determining the image currently displayed in the image library interface as the image to be selected.

FIG. 8 is a schematic diagram of determining an image to be selected according to sliding speed information and sliding distance information according to an embodiment of the present disclosure. As shown in FIG. 8, based on a sliding gesture input by a user on an image library interface, corresponding sliding speed information and sliding distance information are obtained. When the scroll speed v is less than the speed threshold value threshold_V and the scroll distance d represented by the scroll distance information is less than the distance threshold value threshold_D, it means that the moving speed of the slide gesture is slow and the moving distance is short, and it may be determined that the slide gesture is at the precise positioning stage at this time. In this case, the image currently displayed in the image library interface may be selected by the user. Therefore, the image currently displayed in the image library interface may be selected by the user, and determined as the image to be selected; otherwise, if the scrolling speed is greater than a speed threshold value, or the scrolling distance represented by the scrolling distance information is greater than a distance threshold value, it means that the sliding gesture has a fast moving speed or a long moving distance, and it may be determined that the sliding gesture is in a rough positioning stage at this time, Then, the image to be selected is not determined.

Further, after the image to be selected is determined, the image to be selected is decoded to obtain a high-resolution image corresponding to the image to be selected, and the high-resolution image is used as a thumbnail of the image to be selected and loaded to a memory. This process is not repeated herein.
Step S202: create a first renderer by means of a sub-process, and render a thumbnail on a target display control using the first renderer, where the target display control is used for displaying an image to be edited in an image editing interface.
Step S203: obtain an image to be edited by decoding the target image.
Step S204: obtain size information of the image to be edited, whereby the size information represents an image size of the image to be edited.
Step S205: initialize the image editing interface based on the size information of the image to be edited.

For example, after or in parallel to step S204, by using the main process or an additional sub-process, the target image determined at the previous step is decoded to obtain a decoded image in the memory, that is, an image to be edited. An image editing interface is an interface for displaying and editing the image to be edited, and therefore the initialization of the image editing interface needs to be implemented based on the size information of the image to be edited. The obtaining the image size of the image to be edited includes, for example, image width, image height, horizontal resolution, vertical resolution, bit depth, etc. A specific implementation solution for obtaining the size information of the image is known to a person skilled in the art, and thus is not detailed herein.

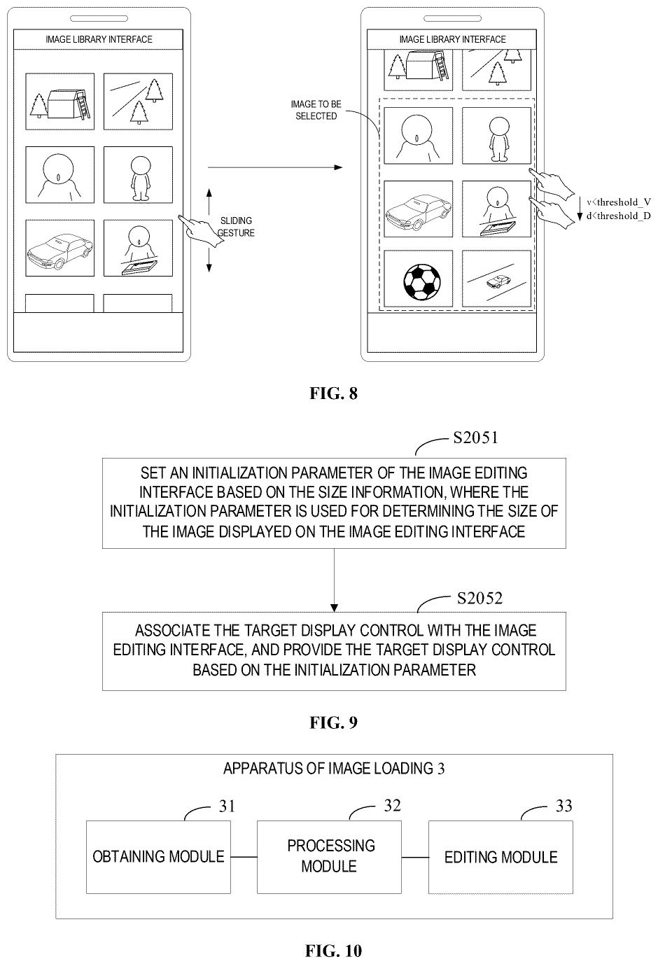

For example, as shown in FIG. 9, step S205 includes two specific steps in implementations, step S2051 and step S2052.
Step S2051: set an initialization parameter of the image editing interface based on the size information, where the initialization parameter is used for determining the size of the image displayed on the image editing interface.
Step S2052: associate the target display control with the image editing interface, and provide the target display control based on the initialization parameter.

For example, taking an Android system as an example, the image editing interface is implemented through an activity, and a control (view) for implementing various functions may be associated in the activity. In the embodiments of the present disclosure, an initialization parameter of an image editing interface is determined based on size information, and each control in the image editing interface is initialized based on the initialization parameter, so that the control in the image editing interface is in a triggerable state. Furthermore, the target display control is associated with the image editing interface, so that the image editing interface displays a corresponding image to be edited through the target display control. The target display control needs to be provided by using an initialization parameter, so that the target display control may match an image to be edited. Thus, the provided set target display control may display the input high-resolution image to be edited after the image editing interface is initialized. A specific implementation process of initializing an image editing interface is known to a person skilled in the art, and thus is not repeated herein.
Step S206: after the initialization of the image editing interface is completed, re-render the image to be edited on the target display control.

Further, after the image editing interface is initialized, the image editing interface may redraw an image to be edited through the associated target display control, and edit the image to be edited based on various other function controls in the image to be edited. The specific implementation process has been described in detail at step S103 in the embodiment shown with respect to FIG. 3, and thus is not repeated herein.

In the embodiment of the present disclosure, the implementation of step S202 is the same as the implementation of step S102 in the embodiment shown in FIG. 3 of the present disclosure, and will not be redundantly described herein.

Corresponding to the method of image loading in the foregoing embodiments, FIG. 10 is a structural block diagram of an apparatus of image loading according to an embodiment of the present disclosure. For ease of description, only parts related to the embodiments of the present disclosure are shown. Referring to FIG. 10, the apparatus of image loading 3 includes:
An obtaining module 31 configured for obtaining a thumbnail of a target image in response to a selection operation for the target image, the thumbnail of the target image being preloaded in a memory.
A processing module 32 configured for rendering the thumbnail on a target display control, wherein the target display control is provided in an image editing interface, and the target display control is invoked by the image editing interface to display an image loaded to the image editing interface.
An editing module 33 configured for decoding the target image to obtain an image to be edited, and re-rendering the image to be edited to a target display control via the image editing interface after the image editing interface is initialized.

In one embodiment of the present disclosure, the target image is displayed in an image library interface, and the obtaining module 31 is further configured for obtaining an operation instruction for the image library interface, the operation instruction being used for scrolling and displaying an image in the image library interface; and the editing module 33 is further configured for determining an image to be selected based on the instruction, decoding the image to be selected, and generating a thumbnail of the image to be selected.

In one embodiment of the present disclosure, the processing module 32 is specifically configured for: creating a first renderer, wherein the first renderer is a lightweight renderer; rendering the thumbnail onto a preloaded target display control through the first renderer; and the editing module 33 is specifically configured for re-rendering the image to be edited onto the target display control with a second renderer created at a stage of the initialization of the image editing interface.

In one embodiment of the present disclosure, the obtaining module 31 is specifically configured for, when obtaining the operation instruction for the image library interface, generating the operation instruction in response to a sliding gesture for the image library interface, wherein the operation instruction comprises scrolling speed information and scrolling distance information, the sliding speed information indicates a scrolling speed at which the displayed image is scrolled in the image library interface, and the sliding distance information indicates a scrolling distance for which the displayed image is scrolled in the image library interface.

The obtaining module 31 is further configured for determining an image to be selected based on the rolling speed information and the rolling distance information.

In an embodiment of the present disclosure, when determining an image to be selected based on the sliding speed information and the sliding distance information, the obtaining module 31 is specifically configured for: in response to that the scrolling speed indicated by the scrolling speed information is less than a speed threshold and the scrolling distance indicated by the scrolling distance information is less than a distance threshold, determining the image currently displayed in the image library interface as the image to be selected.

In one embodiment of the present disclosure, after an image to be edited is obtained by decoding the target image, the editing module 33 is further configured for obtaining size information of the image to be edited, wherein the size information indicates an image size of the image to be edited; and initializing an image editing interface based on the size information about the image to be edited.

In one embodiment of the present disclosure, when the editing module 33 initializes the image editing interface based on the size information of the image to be edited, the editing module 33 is specifically configured for: setting an initialization parameter of the image editing interface based on the size information, wherein the initialization parameter is used for determining a size of an image displayed on the image editing interface; and associating the target display control with the image editing interface, and providing the target display control based on the initialization parameter.

In one embodiment of the present disclosure, the image editing interface comprises a first display area and a second display area, and the target display control is provided in the first display area.

After creating the first renderer, the processing module 32 is further configured for rendering a map corresponding to the function control of the image editing interface in the second display area.

In one embodiment of the present disclosure, after the image to be edited is re-rendered to the target display control through the image editing interface, the obtaining module 31 is further configured for: in response to an editing instruction for the image to be edited, editing the image to be edited to obtain an edited image; obtaining a thumbnail corresponding to the edited image by compressing the edited image; and loading the thumbnail corresponding to the edited image to the memory.

The obtaining module 31, the processing module 32 and the editing module 33 are connected in sequence. The apparatus of image loading 3 provided in the embodiment of the present disclosure may execute technical solutions of the above method embodiments, and the implementation principle and technical effect thereof are similar, which are not repeated in embodiments of the present disclosure.

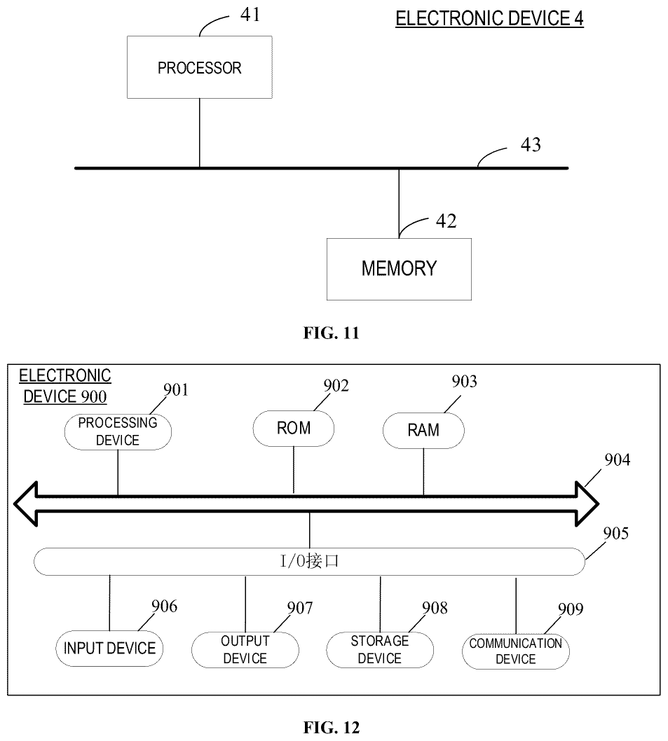

FIG. 11 is a schematic structural diagram of an electronic device according to an embodiment of the present disclosure. As shown in FIG. 11, the electronic device 4 includes:
a processor 41, and a memory 42 that is in communication connection with the processor 41;
the memory 42 storing computer executable instructions; and
the processor 41 executing the computer executable instructions stored in the memory 42, so as to implement the method of image loading in the embodiments shown in FIG. 3 to FIG. 8.

Optionally, the processor 41 and the memory 42 are connected by using a bus 43.

The related descriptions may be understood with reference to the related descriptions and effects corresponding to the steps in the embodiments corresponding to FIG. 3 to FIG. 8, and will not be repeated redundantly herein.

Referring to FIG. 12, which illustrates a schematic diagram of an electronic device 900 suitable for implementing the embodiments of the present disclosure, the electronic device 900 may be a terminal device or a server. The terminal device may include, but is not limited to, a mobile terminal such as a mobile phone, a laptop computer, a digital broadcast receiver, a personal digital assistant (Personal Digital Assistant, PDA for short), a tablet computer (Portable Android Device, PAD for short), a portable multimedia player (Portable Media Player, PMP for short), a vehicle-mounted terminal (for example, a vehicle-mounted navigation terminal), and the like, and a fixed terminal such as a digital TV, a desktop computer, and the like. The electronic device shown in FIG. 12 is merely an example and does not suggest any limitation to the functions and scope of use of the embodiments of the present disclosure.

As shown in FIG. 12, the electronic device 900 may include processing device (e. g., a central processor unit, graphics processor, etc.) 901 that may perform various suitable actions and processes in accordance with a program stored in read only memory (ROM) 902 or a program loaded into random access memory (RAM) 903 from a storage device 908. In the RAM 903, various programs and data necessary for the operation of the electronic device 900 are also stored. The processing device 901, the ROM 902, and the RAM 903 are connected to each other via a bus 904. An input/output (I/O) interface 905 is also connected to the bus 904.

In general, the following devices may be connected to the I/O interface 905: an input device 906 including, for example, a touch screen, a touch pad, a keyboard, a mouse, a camera, a microphone, an accelerometer, a gyroscope, or the like; an output device 907 including, for example, a liquid crystal display (LCD), a speaker, a vibrator, or the like; a storage device 908 including, for example, a magnetic tape, a hard disk, or the like; and a communication device 909. The communication device 909 may allow the electronic device 900 to communicate wirelessly or wired with other devices to exchange data. While FIG. 12 illustrates the electronic device 900 with a variety of devices, it should be understood that it is not required that all of the illustrated devices be implemented or provided. More or fewer devices may alternatively be implemented or provided.

In particular, the processes described above with reference to the flowcharts may be implemented as computer software programs in accordance with embodiments of the present disclosure. For example, embodiments of the present disclosure include a computer program product comprising a computer program carried on a computer readable medium. The computer program comprises a program code for executing the method as shown in the flowchart. In such an embodiment, the computer program may be downloaded and installed from the network via the communication device 909, or installed from the storage device 908, or installed from ROM 902. When the computer program is executed by the processing device 901, the above-described functions defined in the method of embodiments of the present disclosure are executed.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to, wireline, optical fiber cable, RF (radio frequency), etc., or any suitable combination of the foregoing.

The computer readable medium may be included in the electronic device, or may exist separately and not be installed in the electronic device.

The computer readable medium bears one or more programs, and when the one or more programs are executed by an electronic device, the electronic device is enabled to execute the method shown in the foregoing embodiments.

Computer program codes for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The units involved in the embodiments of the present disclosure may be implemented through software or hardware. The name of a unit does not constitute a limitation to the unit itself in a certain case. For example, the obtaining module may also be described as “a module for obtaining a thumbnail of a target image in response to a selection operation on the target image”.

The functions described herein above may be performed, at least in part, by one or more hardware logic components. For example, without limitation, exemplary types of hardware logic components that may be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

In a first aspect, according to one or more embodiments of the present disclosure, there is provided an method of image loading, comprising:
in response to a selection operation for a target image, obtaining a thumbnail of the target image, the thumbnail of the target image being preloaded in a memory; rendering the thumbnail on a preloaded target display control, wherein the target display control is provided in an image editing interface, and the target display control is used for being called by the image editing interface so as to display an image loaded on the image editing interface; and obtaining an image to be edited by decoding the target image, and re-rendering, after an initialization of the image editing interface is completed, the image to be edited on the target display control through the image editing interface.

According to one or more embodiments of the present disclosure, the rendering the thumbnail on a preloaded target display control comprises: creating a first renderer, the first renderer being a lightweight renderer; and rendering, with the first renderer, the thumbnail on the preloaded target display control; and wherein re-rendering the image to be edited on the target display control through the image editing interface comprises: re-rendering, with a second renderer created at a stage of the initialization of the image editing interface, the image to be edited on the target display control.

According to one or more embodiments of the present disclosure, the target image is displayed in an image library interface, and the method further comprises: obtaining an operation instruction for the image library interface, the operation instruction being used for scrolling and displaying an image in the image library interface; and determining an image to be selected based on the operation instruction, decoding the image to be selected, and generating a thumbnail of the image to be selected.

According to one or more embodiments of the present disclosure, obtaining an operation instruction for the interface of the image library comprises: in response to a sliding gesture for the image library interface, generating the operation instruction, wherein the operation instruction comprises scrolling speed information and scrolling distance information, the sliding speed information indicates a scrolling speed at which the displayed image is scrolled in the image library interface, and the sliding distance information indicates a scrolling distance for which the displayed image is scrolled in the image library interface; and the method further comprises: determining the image to be selected based on the rolling speed information and the rolling distance information.

According to one or more embodiments of the present disclosure, determining the image to be selected based on the sliding speed information and the sliding distance information comprises: in response to that the scrolling speed indicated by the scrolling speed information is less than a speed threshold and the scrolling distance indicated by the scrolling distance information is less than a distance threshold, determining the image currently displayed in the image library interface as the image to be selected.

According to one or more embodiments of the present disclosure, after obtaining an image to be edited by decoding the target image, the method further comprises: obtaining size information about the image to be edited, the size information indicating an image size of the image to be edited; and initializing the image editing interface based on the size information of the image to be edited.

According to one or more embodiments of the present disclosure, the initializing the image editing interface based on the size information of the image to be edited comprises: setting an initialization parameter of the image editing interface based on the size information, wherein the initialization parameter is used for determining a size of an image displayed on the image editing interface; and associating the target display control with the image editing interface, and providing the target display control based on the initialization parameter.

According to one or more embodiments of the present disclosure, the image editing interface comprises a first display area and a second display area, and the target display control is provided in the first display area; and after creating the first renderer, the method further comprises: rendering a map corresponding to a function control of the image editing interface in the second display area.

According to one or more embodiments of the present disclosure, wherein after re-rendering the image to be edited on the target display control through the image editing interface, the method further comprises: in response to an editing instruction for the image to be edited, editing the image to be edited to obtain an edited image; obtaining a thumbnail corresponding to the edited image by compressing the edited image; and loading the thumbnail corresponding to the edited image to the memory.

According to a second aspect, in one or more embodiments of the present disclosure, an apparatus of image loading is provided, including:
an obtaining module configured for obtaining a thumbnail of a target image in response to a selection operation for the target image, the thumbnail of the target image being preloaded in a memory;
a processing module configured for creating a first renderer, and rendering the thumbnail on a target display control by using the first renderer, wherein the target display control is provided in an image editing interface, and the target display control is used for being called by the image editing interface so as to display an image loaded on the image editing interface; and
an editing module configured for obtaining an image to be edited by decoding the target image, and re-rendering, after an initialization of the image editing interface is completed, the image to be edited on the target display control through the image editing interface.

According to one or more embodiments of the present disclosure, the processing module is specifically configured for: creating a first renderer, wherein the first renderer is a lightweight renderer; rendering the thumbnail onto a preloaded target display control through the first renderer; and the editing module 33 is specifically configured for re-rendering the image to be edited onto the target display control with a second renderer created at a stage of the initialization of the image editing interface.

According to one or more embodiments of the present disclosure, the target image is displayed in an image library interface, and the obtaining module is further configured for obtaining an operation instruction for the image library interface, the operation instruction being used for scrolling and displaying an image in the image library interface; and the editing module is further configured for determining an image to be selected based on the operation instruction, decoding the image to be selected, and generating a thumbnail of the image to be selected.

According to one or more embodiments of the present disclosure, when the obtaining module obtains an operation instruction for the image library interface, specifically configured for in response to a sliding gesture for the image library interface, generating the operation instruction, wherein the operation instruction comprises scrolling speed information and scrolling distance information, the sliding speed information indicates a scrolling speed at which the displayed image is scrolled in the image library interface, and the sliding distance information indicates a scrolling distance for which the displayed image is scrolled in the image library interface; and the obtaining module is further configured for determining the image to be selected based on the rolling speed information and the rolling distance information.

According to one or more embodiments of the present disclosure, the obtaining module is configured for obtaining the sliding speed information and the sliding distance information, when the image to be selected is determined, specifically configured for: in response to that the scrolling speed indicated by the scrolling speed information is less than a speed threshold and the scrolling distance indicated by the scrolling distance information is less than a distance threshold, determining the image currently displayed in the image library interface as the image to be selected.

According to one or more embodiments of the present disclosure, after an image to be edited is obtained by decoding the target image, the editing module is further configured for obtaining size information about the image to be edited, the size information indicating an image size of the image to be edited; and initializing the image editing interface based on the size information of the image to be edited.

According to one or more embodiments of the present disclosure, when the editing module initializes the image editing interface based on the size information of the image to be edited, the editing module is specifically configured for: setting an initialization parameter of the image editing interface based on the size information, wherein the initialization parameter is used for determining a size of an image displayed on the image editing interface; and associating the target display control with the image editing interface, and providing the target display control based on the initialization parameter.

According to one or more embodiments of the present disclosure, the image editing interface comprises a first display area and a second display area, and the target display control is provided in the first display area; and after creating the first renderer, the processing module is further configured for rendering a map corresponding to a function control of the image editing interface in the second display area.

According to one or more embodiments of the present disclosure, after the image to be edited is re-rendered to the target display control through the image editing interface, the obtaining module is further configured for: in response to an editing instruction for the image to be edited, editing the image to be edited to obtain an edited image; obtaining a thumbnail corresponding to the edited image by compressing the edited image; and loading the thumbnail corresponding to the edited image to the memory.

According to a third aspect, according to one or more embodiments of the present disclosure, there is provided an electronic device, comprising: a processor and a memory in communication connection with the processor;
the memory storing a computer executable instruction;
the processor executing the computer executable instruction stored in the memory, to implement the method of image loading according to the foregoing first aspect and various possible variations of the first aspect.

In a fourth aspect, according to one or more embodiments of the present disclosure, a computer readable storage medium is provided. The computer readable storage medium stores computer executable instructions. When a processor executes the computer executable instructions, the method of image loading according to the first aspect and various possible variations of the first aspect is implemented.

According to a fifth aspect, an embodiment of the present disclosure provides a computer program product, including a computer program. When being executed by a processor, the computer program implements the method of image loading according to the foregoing first aspect and various possible variations of the first aspect.

According to a sixth aspect, an embodiment of the present disclosure provides a computer program. When being executed by a processor, the computer program implements the method of image loading according to the foregoing first aspect and various possible variations of the first aspect.

Embodiments of the present disclosure provide an method, an apparatus, an electronic device, a storage medium, a computer program product, and a computer program of image loading. In response to a selection operation for a target image, a thumbnail of the target image is obtained, wherein the thumbnail of the target image is preloaded in a memory; the thumbnail is rendered on a preloaded target display control, wherein the target display control is provided in an image editing interface, and the target display control is used for being called by the image editing interface so as to display an image loaded on the image editing interface; the target image is decoded to obtain an image to be edited, and after the initialization of the image editing interface is completed, the image to be edited is re-rendered to the target display control via the image editing interface. Since a thumbnail corresponding to a preloaded target image is rendered on a target display control by configuring an additional lightweight first renderer, the blank screen issue caused before an initialization completion of an image editing interface can be avoided, so that the image editing interface is instantly started based on a user operation visually, thereby improving the smoothness of starting of the image editing interface and improving the use experience.

The foregoing description is merely illustrative of the preferred embodiments of the present disclosure and of the technical principles applied thereto, as will be appreciated by those skilled in the art, The disclosure of the present disclosure is not limited to the technical solution formed by the specific combination of the described technical features, At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination. Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method of image loading, comprising:
in response to a selection operation for a target image, obtaining a thumbnail of the target image, the thumbnail of the target image being preloaded in a memory;
rendering the thumbnail on a preloaded target display control, wherein the target display control is provided in an image editing interface, and the target display control is used for being called by the image editing interface so as to display an image loaded on the image editing interface; and
obtaining an image to be edited by decoding the target image, and re-rendering, after an initialization of the image editing interface is completed, the image to be edited on the target display control through the image editing interface.

2. The method of claim 1, wherein the rendering the thumbnail on a preloaded target display control comprises:
creating a first renderer, the first renderer being a lightweight renderer; and
rendering, with the first renderer, the thumbnail on the preloaded target display control; and
wherein the re-rendering the image to be edited on the target display control through the image editing interface comprises:
re-rendering, with a second renderer created at a stage of the initialization of the image editing interface, the image to be edited on the target display control.

3. The method of claim 1, wherein the target image is displayed in an image library interface, and the method further comprises:
obtaining an operation instruction for the image library interface, the operation instruction being used for scrolling and displaying an image in the image library interface; and
determining an image to be selected based on the operation instruction, decoding the image to be selected, and generating a thumbnail of the image to be selected.

4. The method of claim 3, wherein obtaining an operation instruction for the interface of the image library comprises:
in response to a sliding gesture for the image library interface, generating the operation instruction, wherein the operation instruction comprises scrolling speed information and scrolling distance information, the sliding speed information indicates a scrolling speed at which the displayed image is scrolled in the image library interface, and the sliding distance information indicates a scrolling distance for which the displayed image is scrolled in the image library interface; and
wherein the method further comprises:
determining the image to be selected based on the rolling speed information and the rolling distance information.

5. The method of claim 4, wherein determining the image to be selected based on the sliding speed information and the sliding distance information comprises:
in response to that the scrolling speed indicated by the scrolling speed information is less than a speed threshold and the scrolling distance indicated by the scrolling distance information is less than a distance threshold, determining the image currently displayed in the image library interface as the image to be selected.

6. The method of claim 1, wherein after obtaining an image to be edited by decoding the target image, the method further comprises:
obtaining size information about the image to be edited, the size information indicating an image size of the image to be edited; and
initializing the image editing interface based on the size information of the image to be edited.

7. The method of claim 6, wherein the initializing the image editing interface based on the size information of the image to be edited comprises:
setting an initialization parameter of the image editing interface based on the size information, wherein the initialization parameter is used for determining a size of an image displayed on the image editing interface; and
associating the target display control with the image editing interface, and providing the target display control based on the initialization parameter.

8. The method of claim 1, wherein the image editing interface comprises a first display area and a second display area, and the target display control is provided in the first display area; and
wherein, after creating the first renderer, the method further comprises:
rendering a map corresponding to a function control of the image editing interface in the second display area.

9. The method of claim 1, wherein after re-rendering the image to be edited on the target display control through the image editing interface, the method further comprises:
in response to an editing instruction for the image to be edited, editing the image to be edited to obtain an edited image;
obtaining a thumbnail corresponding to the edited image by compressing the edited image; and
loading the thumbnail corresponding to the edited image to the memory.

10. (canceled)

11. An electronic device, comprising: a processor, and a memory communicatively connected to the processor;
the memory storing computer executable instructions; and
the processor executing the computer executable instructions stored in the memory, to implement acts comprising:
in response to a selection operation for a target image, obtaining a thumbnail of the target image, the thumbnail of the target image being preloaded in a memory;
rendering the thumbnail on a preloaded target display control, wherein the target display control is provided in an image editing interface, and the target display control is used for being called by the image editing interface so as to display an image loaded on the image editing interface; and
obtaining an image to be edited by decoding the target image, and re-rendering, after an initialization of the image editing interface is completed, the image to be edited on the target display control through the image editing interface.

12. A non-transitory computer readable storage medium, the computer readable storage medium having computer executable instructions stored thereon, the computer executable instructions, when executed by a processor, implementing acts comprising:
in response to a selection operation for a target image, obtaining a thumbnail of the target image, the thumbnail of the target image being preloaded in a memory;
rendering the thumbnail on a preloaded target display control, wherein the target display control is provided in an image editing interface, and the target display control is used for being called by the image editing interface so as to display an image loaded on the image editing interface; and
obtaining an image to be edited by decoding the target image, and re-rendering, after an initialization of the image editing interface is completed, the image to be edited on the target display control through the image editing interface.

13. (canceled)

14. (canceled)

15. The device of claim 11, wherein the rendering the thumbnail on a preloaded target display control comprises:
creating a first renderer, the first renderer being a lightweight renderer; and
rendering, with the first renderer, the thumbnail on the preloaded target display control; and
wherein the re-rendering the image to be edited on the target display control through the image editing interface comprises:
re-rendering, with a second renderer created at a stage of the initialization of the image editing interface, the image to be edited on the target display control.

16. The device of claim 11, wherein the target image is displayed in an image library interface, and the acts further comprise:
obtaining an operation instruction for the image library interface, the operation instruction being used for scrolling and displaying an image in the image library interface; and
determining an image to be selected based on the operation instruction, decoding the image to be selected, and generating a thumbnail of the image to be selected.

17. The device of claim 16, wherein obtaining an operation instruction for the interface of the image library comprises:
in response to a sliding gesture for the image library interface, generating the operation instruction, wherein the operation instruction comprises scrolling speed information and scrolling distance information, the sliding speed information indicates a scrolling speed at which the displayed image is scrolled in the image library interface, and the sliding distance information indicates a scrolling distance for which the displayed image is scrolled in the image library interface; and
wherein the acts further comprise:
determining the image to be selected based on the rolling speed information and the rolling distance information.

18. The device of claim 17, wherein determining the image to be selected based on the sliding speed information and the sliding distance information comprises:
in response to that the scrolling speed indicated by the scrolling speed information is less than a speed threshold and the scrolling distance indicated by the scrolling distance information is less than a distance threshold, determining the image currently displayed in the image library interface as the image to be selected.

19. The device of claim 11, wherein after obtaining an image to be edited by decoding the target image, the acts further comprise:
obtaining size information about the image to be edited, the size information indicating an image size of the image to be edited; and
initializing the image editing interface based on the size information of the image to be edited.

20. The device of claim 19, wherein the initializing the image editing interface based on the size information of the image to be edited comprises:
setting an initialization parameter of the image editing interface based on the size information, wherein the initialization parameter is used for determining a size of an image displayed on the image editing interface; and
associating the target display control with the image editing interface, and providing the target display control based on the initialization parameter.

21. The device of claim 11, wherein the image editing interface comprises a first display area and a second display area, and the target display control is provided in the first display area; and
wherein, after creating the first renderer, the acts further comprise:
rendering a map corresponding to a function control of the image editing interface in the second display area.

22. The device of claim 11, wherein after re-rendering the image to be edited on the target display control through the image editing interface, the acts further comprise:
in response to an editing instruction for the image to be edited, editing the image to be edited to obtain an edited image;
obtaining a thumbnail corresponding to the edited image by compressing the edited image; and
loading the thumbnail corresponding to the edited image to the memory.

23. The non-transitory computer readable storage medium of claim 12, wherein the rendering the thumbnail on a preloaded target display control comprises:
creating a first renderer, the first renderer being a lightweight renderer; and
rendering, with the first renderer, the thumbnail on the preloaded target display control; and
wherein the re-rendering the image to be edited on the target display control through the image editing interface comprises:
re-rendering, with a second renderer created at a stage of the initialization of the image editing interface, the image to be edited on the target display control.
